(19) United States
(12) Patent Application Publication
(10) Pub. No.: US 2025/0031686 A1
(43) Pub. Date: Jan. 30, 2025

(54) HUNTER SADDLE WITH INTEGRAL POCKETS

(71) Applicant: AVID STRATEGIC LLC, Frankenmuth, MI (US)

(72) Inventors: SCOTT LEE, FRANKENMUTH, MI (US); BLAKE LOUGHEED, TRAVERSE CITY, MI (US)

(21) Appl. No.: 18/226,137

(22) Filed: Jul. 25, 2023

(51) Int. Cl. A01M 31/02; A62B 35/00

(52) U.S. Cl. CPC A01M 31/02; A62B 35/0012; A62B 35/0037

(57) ABSTRACT

A hunting saddle assembly includes a saddle made of a sling of flexible saddle fabric having a main body portion forming a seat for supporting the backside of a hunter and having side portions extending in opposite lateral directions from the main body portion for wrapping about the hips of the hunter. At least one coupling is provided which is connectible to a tether line for suspending the saddle and hunter in a tree. The assembly includes at least one pocket formed as an integral part of the saddle and having an opening positioned along at least one of the side portions and accessible to the hunter while suspended in the tree.

### BACKGROUND

### 1. Technical Field

This invention relates generally to hunting saddles used by hunters for suspending themselves at an elevated position in a tree from a tether line. The invention relates more specifically to storage features for hunting saddles.

### 2. Related Art

Hunters, and particularly mobile bow hunters, use hunting saddles to suspend themselves in a tree during hunting. A typical hunting saddle includes a sling of fabric that wraps about the back side of the hunter to form a seat. A bridge of the saddle attaches to a tether line around the tree with a carabiner.

Typical hunting saddles are very minimalist in design and lack the ability to store items often needed during a hunt, such as a lineman's rope, game calls and other accessories. One known option is to attach a separate sack or pouch to loops of Molle webbing provided on the back of the saddle along the belt line. The problem with the separate pouch approach is that the pouch moves and swings relative to the saddle. Such movement can distract wild game and can cause unwanted noise during hunting. The free-swinging pouch can also move out of position depending on the orientation of the hunter in the tree, making it difficult for the hunter to easily locates and access the opening of pouch when needed which can cause unwanted frustration, movement and noise.

### SUMMARY

A hunting saddle assembly comprises a saddle made of a sling of flexible saddle fabric having a main body portion forming a seat for supporting the backside of a hunter and having side portions extending in opposite lateral directions from the main body portion for wrapping about the hips of the hunter. At least one coupling is connectible to a tether line for suspending the saddle and hunter in a tree. At least one pocket is provided and formed as an integral part of the saddle. The pocket has an opening positioned along at least one of the side portions and accessible to the hunter while suspended in the tree.

A method of supporting a hunter suspended in a tree with access to a storage pouch, comprises providing a saddle made of flexible saddle fabric having a main body portion and side portions extending in opposite lateral directions from the main body portion. The method further includes arranging the saddle to position the main body portion about the hunter's back side and to wrap the side portions along the hips of the hunter. The method further includes attaching the saddle to a tether line secured to the tree to suspend the saddle and hunter and to enable the hunter to move between a seated position and a standing position. The method further includes providing at least one integral pocket panel fixed on the saddle to define a storage pocket for holding selected items and which moves with the saddle and hunter between the seated and standing positions and including an opening of the storage pocket positioned along at least one of the side portions for access by the hunter when in the seated and standing positions.

The saddle assembly and method have the advantage of integrating at least one storage pocket on the saddle. The pocket is part of the saddle assembly and thus moves with the saddle and hunter to minimize noise and the opening to the pocket is fixed and is readily accessible to the hunter in all positions of tethered hunting, including sitting and standing positions.

A particular advantage is that the pocket can be formed in part by the saddle fabric itself. A pocket panel of a separate material is positioned to overly a portion of the saddle fabric and secured along its perimeter to delineate an enclosed space or pouch, with a portion of the perimeter of the panel being left unsewn to define an access opening into the space. Minimal material is used in making the pocket, which is unlike a separate bag-like pouch where the entire pouch is made of pouch material and does not utilize the saddle fabric. The pocket panel thus can be made lighter in weight than known pouches. A further advantage of the integrated pocket panel is that the opening can be ideally pre-oriented to be accessible to the hunter in all positions of the hunter. In particular, saddle hunters utilize a tree platform which enables the hunter to place one or both feet on the platform while suspended and while leaning away from the tree in a so-called “standing position” wherein the hunter's body is inclined about 40-45 degrees away from a longitudinal axis of the tree trunk. Saddle hunters may also position themselves in a squatting or so-called “sitting position” wherein their knees are bent and sometimes braced against the tree trunk and their feet suspended or supported on the tree platform. Moving between the standing and sitting positions moves the hunter's hips and thus their saddle and the saddle panels move with them. This is unlike the free-swinging bag-type pouches which suspend from the saddle and swing back and away from the hunter when moving to the sitting position. The opening of the integrated saddle pouch, on the other hand, is strategically positioned along the side portions of the saddle that wraps about the hips and is further strategically angled relative to the beltline of the saddle (inclined front-to-back) to provide fixed and ready access to the hunter when in both the sitting and standing positions. The hunter does not have to search for the pouch or pouch opening since it moves with the hunter and does not swing free and away from the hunter with positional adjustments of the hunter. The angulation of the opening can further be advantageously oriented such that the hunter can reach down along the hunter's hips to access the opening in both the standing and sitting positions with a natural motion. When in the standing position, the opening is approximately parallel with horizontal (the ground) or may be angled up to 15 to 40 degrees downward from horizontal, providing ready access from above to the hunter. When moved to the sitting position, the opening moves with the hunter and is now closer to horizontal in the range of 0 to 15 degrees from horizontal, likewise providing ready and natural-positon access from above to the hunter. And since the pocket is formed as a united part of the saddle and moves with the saddle, the hunter always knows where it is and can access the pocket instinctively and without looking, thus minimizing body movement which can draw unwanted attention from wild game.

A further advantage of the inventive pouch is that the pouch panel can be made of a different fabric material than that used to make the saddle. The pouch panel can be advantageously made of a stretchable material, such as 4-way stretch fabric, which enables the pouch panel to stretch in order to accommodate large or bulky objects. The elastically stretchable fabric also enables the opening to stretch for ease of accessing the pouch and for placing or removing contents. A further advantage of the stretch fabric is that the pouch panel can be integrated with the saddle and not impede the flexibility or fit of the saddle. In other words, the addition of the pouch panel does not negatively affect the fit and operation of the saddle for its intended purpose. The flexible fabric can also be much lighter and thinner than the saddle fabric, thus adding negligible weight to the overall saddle assembly, even when a pocket is provided on both sides of the saddle assembly.

A further advantage of the inventive pouch is that there is less chance of misplacing objects when stowing them in the pouch while suspended. Knowing exactly where the opening is located and having it be easily accessible from above in both the standing and sitting positions, there is little chance of misplacing the object especially if accessing the pockets blindly. This is unlike sling-like pouches which swing free and present the chance of missing the opening or only partially placing the objects in the pouch, particularly in the sitting position, since the hunter may not be able to readily see the opening and not have instincts as to exactly where the opening its since it shifts under gravity with the movement of the sling pouch relative to the saddle.

Yet another advantage of the inventive pouch is that essential accessories or equipment needed by the hunter can be stowed in the pouch and will always be there when needed. This may not be the case with sling-type pouches which can be hooked and unhooked from the saddle and thus forgotten or misplaced or positioned differently on the saddle between hunting sessions.

### THE DRAWINGS

These and other features and advantages will be better understood and appreciated when considered in connection with the following detailed description and drawings, in which:

FIG. 1 is an environmental view of an embodiment of a saddle assembly;

FIG. 2 is a front perspective view of the saddle assembly;

FIG. 3 is a rear perspective view of the saddle assembly;

FIG. 4 is a front side plan view of the saddle assembly;

FIG. 5 is a rear side plan view of the saddle assembly;

FIG. 6 is an enlarged environmental side view of the saddle being used in a standing position of a hunter;

FIG. 7 is a view like FIG. 6 but in a sitting position of the hunter;

FIG. 8 is an enlarged fragmental front side plan view showing details of a pocket portion of the saddle assembly; and

FIG. 9 is a cross-sectional view taken along lines 9-9 of FIG. 8 showing further details of the pocket portion.

### DETAILED DESCRIPTION

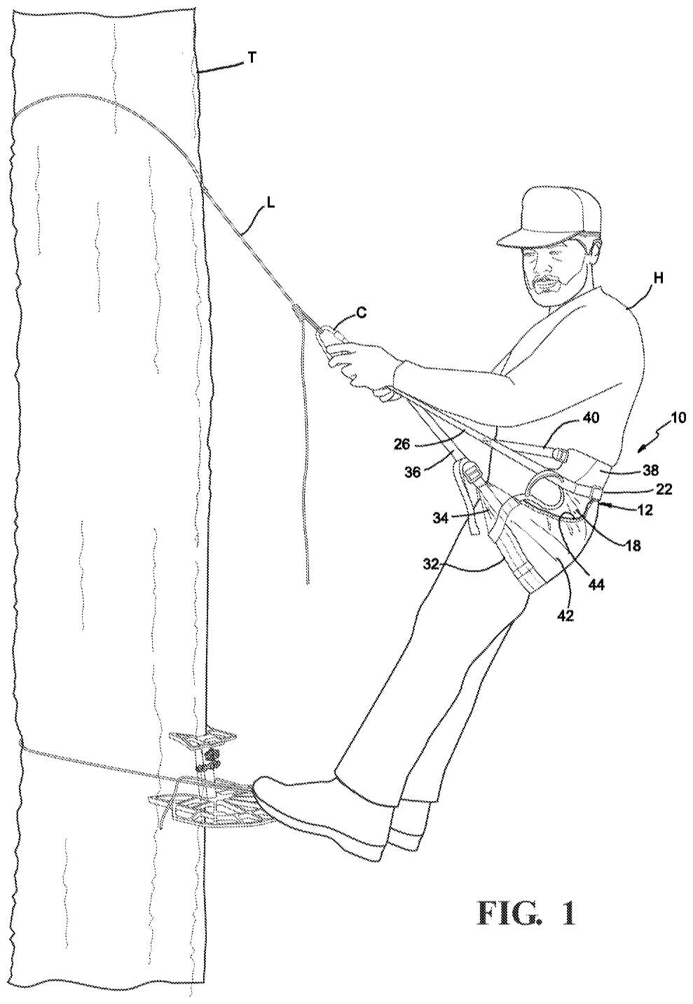

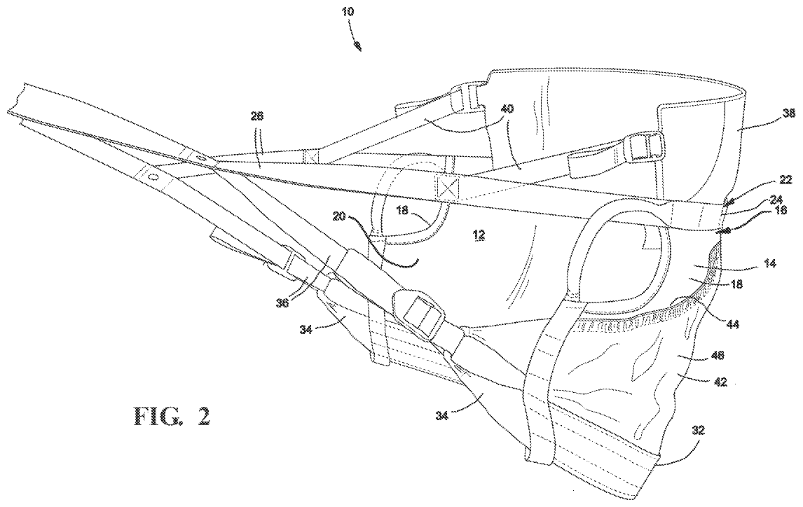

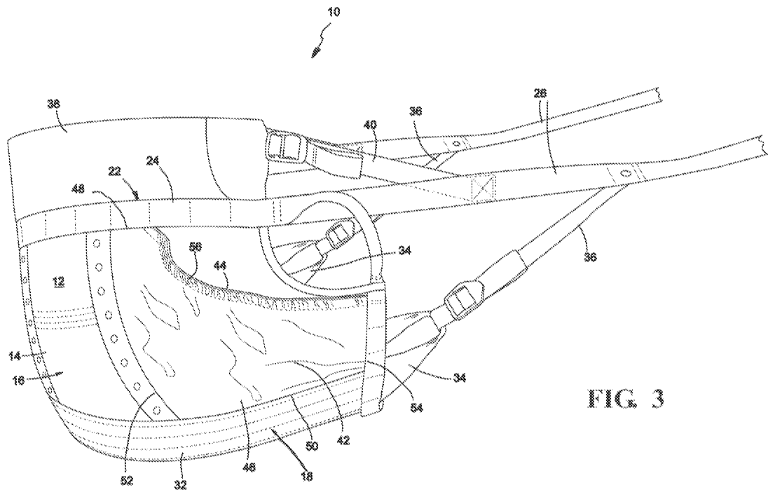

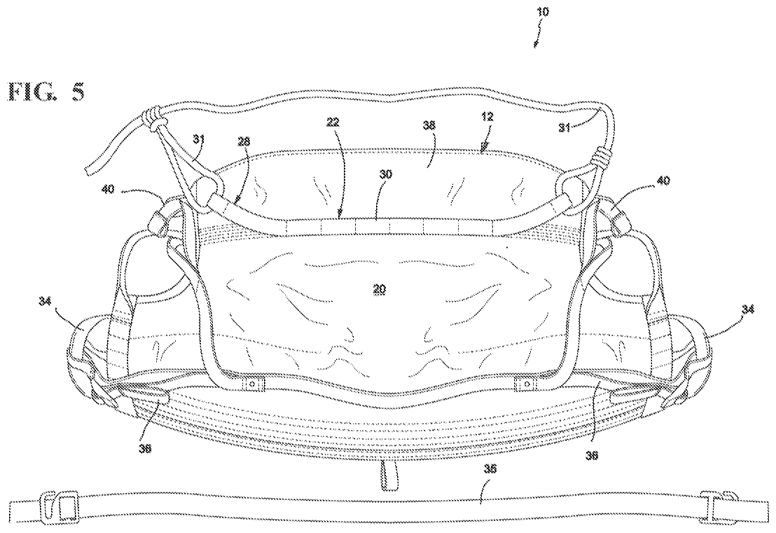

A saddle assembly constructed according to an embodiment is illustrated generally at 10 in the figures. With initial reference to FIG. 1, the assembly 10 comprises a saddle 12 that is worn by a hunter H and connectible to a tether line L with a carabiner that is secured to the tree T. Referring additionally to FIGS. 2-4, the saddle 12 comprises a sling of flexible saddle fabric 14 having a main body portion 16 forming a seat for supporting the backside of a hunter H and having side portions 18 extending in opposite lateral directions from the main body portion 16 for wrapping about the hips of the hunter H. The main body 16 and side portions 18 may be fabricated of the same fabric material and may further be fabricated as a single panel structure. The saddle fabric 14 may include, for example, NYCO Ripstop which is a 50/50 blend of nylon and cotton fibers that is hard wearing, durable and non-stretchable. The flexible but non-stretchable saddle fabric 14 offers firm, stable and comfortable support to the hunter H while suspended. The saddle fabric 14 is present and can be seen on at least the exterior of the saddle 12. The opposite inner side of the saddle 12 may or may not be lined. In a preferred embodiment, a liner 20 of the same or similar fabric material as that used for the saddle material 14 is provided to the inner side of the saddle 12, as can best be seen in FIG. 5. The liner 20 presents a smooth and unobstructed finish to the saddle 12 and covers various seams and raw fabric edges of the saddle fabric 14 and related straps, webbing, etc. that would otherwise be visible and would otherwise come into direct contact with the hunter H when wearing the saddle 12.

The assembly 10 includes various straps and belts to secure the saddle 12 to the user and which form a coupling to attach the saddle 12 to a tether line secured to the tree T. The saddle 12 includes a belt line 22 which comprises a length of outer belt line webbing 24, preferably Molle webbing, that is sewn to the saddle 12 and extends crosswise of the main body 16 along a line which will be defined as the waistline of the hunter H. The outer belt line webbing 24 projects beyond the saddle fabric 14 and forms a main anchor loop or bridge 26 that projects forwardly of the saddle 12 when worn and connects to the tether line L by the carabiner C.

An inner waist belt 28 is provided on the inner side of the saddle 12 and may comprise a length of inner webbing 30 overlying the liner 20 and sewn through to the outer webbing 24. Rope ends 312 extend from the inner webbing 30 and are releasably and adjustably securable about the waist of the hunter H for attaching the saddle 12 to the hunter H.

A length of bottom webbing 32 extends across the bottom edge of the saddle 12 in position to underly a hunter's thighs. The webbing 32, at each end, extends beyond a bottom edge of the respective side portions 18 of the saddle 12 and turns back and is sewn to the top edge of the respective side portions 18 to form two bottom anchor loops 34. Leg straps 35 extend from the webbing 34 and are wrappable about the hunter's thighs and releasably secured by adjustment buckles 37. An adjustable length straps 36 are secured to the respective loops 34 and are further secured to the bridge 26. The straps 36 enable the hunter to shorten or lengthen the straps 36 to draw or release the bottom portion of the saddle 12 to accommodate different size hunters and to adjust for comfort. Shortening the straps creates more of a cradling effect to the bottom, backside or buttocks of the hunter H and may be adjusted when the hunter moves between standing and sitting positions while suspended as desired.

The main body portion 16 includes a backrest portion 38 which resides above the belt line 22 and extends crosswise. The backrest portion 38 is configured to rise up and support the small back region of the hunter H when suspended. Backrest adjustment straps 40 extend from each side of the backrest portion 38. Advantageously, the backrest adjustment straps 40 are fixed to the bridge 26, preferably sewn, at a location to provide sufficient length for adjustment and to avoid excessive strap material spanning an otherwise open space forward of the saddle 12. The backrest adjustment straps 40 are thus strategically short and connect to the bridge 26 at a location closer to the saddle 12 as compared to the location of the bottom adjustment straps 36. According to a preferred non-limiting embodiment, the backrest adjustment straps 40 are secured about midway between the anchor point of the bottom adjustment straps 36 and the saddle 12, which positions the backrest adjustment straps 40 low and out of the way of the hunter H in use, while still providing ready access to the adjustment for pulling the backrest portion 38 forward with shortening of the straps 40 or allowing the backrest portion 38 to recline with lengthening of the straps 40, for fore and aft adjustment in the postioning of the backrest portion 38. The straps 40 have pull loops at their free ends for ease of grasping by the hunter H.

According to a further preferred feature, the saddle 12 includes at least one pocket 42 and preferably at least two pockets formed as an integral part of the saddle 12 having an openings 44 positioned along the respective side portions 18 and readily accessible to the hunter H while suspended in the tree T.

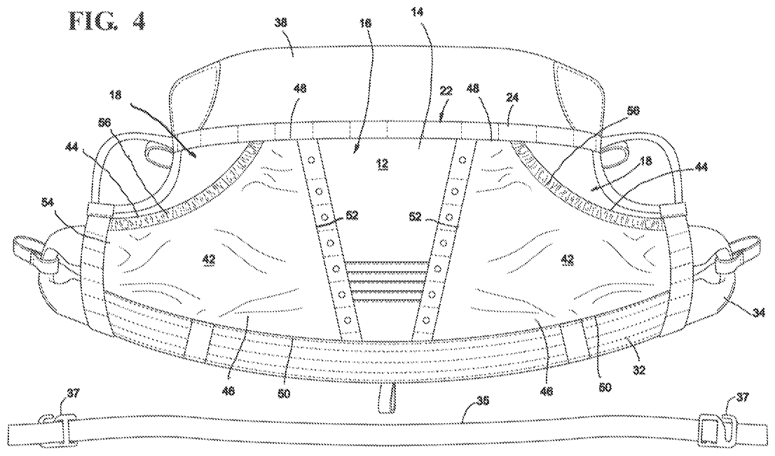

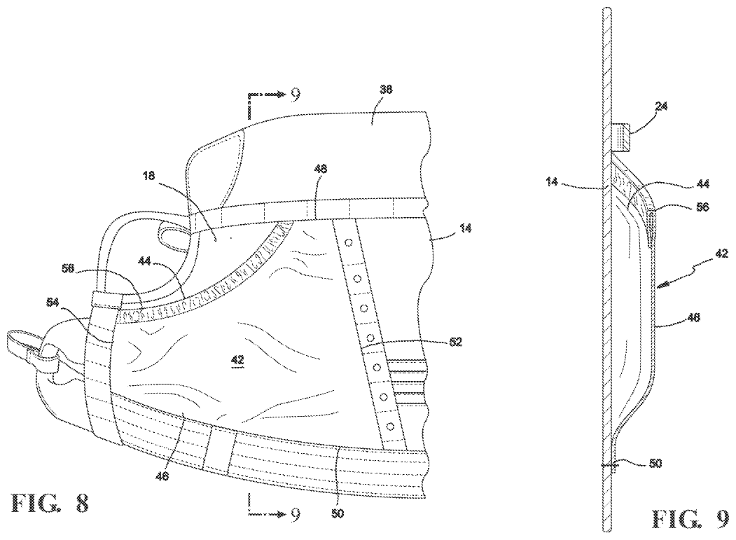

With initial reference to FIGS. 8 and 9, the pockets 42 preferably comprise a panel of flexible pocket fabric 46 secured to the saddle fabric 14. The pocket panels 46 are preferably secured by sewing. The pocket panel fabric 46 is preferably external to the saddle fabric 14. The pocket panel fabric 46 is a different material than that of the saddle fabric 14. According to a preferred embodiment, the pocket panel fabric 46 is not only flexible but is elastically stretchable and the volume of the pocket is elastically expandable. The fabric for the pocket panel 46 may comprise 4-way stretch nylon/spandex woven fabric, such as SAM2® available from MMI Textiles of Brooklyn, Ohio which has 86% nylon and 14% spandex. The expansion from elasticity accommodates large or bulky objects. The opening 44 is also elastically expandable. As shown best in FIG. 8, the panel of pocket fabric 46 includes a top edge 48 that is relatively shorter than the bottom edge 50 and is sewn to the saddle fabric 14. The panel 46 further includes a back edge 52 that extends transversely of the bottom and top edges 50, 48 and is sewn to the saddle fabric 14. The panel 46 further includes a forward edge 54 that is relatively shorter than the back edge 52 and is sewn to the saddle fabric 14. The panel 46 further includes a forwardly disposed rim portion 56 that extends between the top and forward edges 48, 54 of the panel 46 and that is not sewn to the saddle fabric 14 and which defines the opening 44 of the pocket 42. The rim portion 56 preferably extends at an acute angle between the top and forward edges 48, 54 of the panel 46. It will also be seen that the forward edge 54 is spaced forwardly of the top edge 48. The opening 44 of each pocket is angled relative to the belt line 22 and the openings 44 of the opposing pockets 42 are oppositely inclined relative to one another as shown best in FIG. 4. The angle of inclination relative to the belt line 22 may range from 10 to 45 degrees and presents the openings 44 as forward tilting from back to front. The openings 44 are disposed along the respective side portions 18 of the saddle 12. The two pockets 42 have mirror symmetry. The backing for the space created by the pocket panels 46 is the saddle fabric 14, as seen in FIG. 9, such that the pocket space is delineated on the front side by the pocket panel 46 and on the back side by the saddle fabric 14 and with the perimeter of the pockets 42 defined by seams where the edges 48, 50, 52 and 54 are sewn to the saddle fabric 14. The rim portion 56 of the pocket panel 46 is not sewn and is moveable relative to the saddle fabric 14 to define the opening 44 to gain access to the space within the pocket 42.

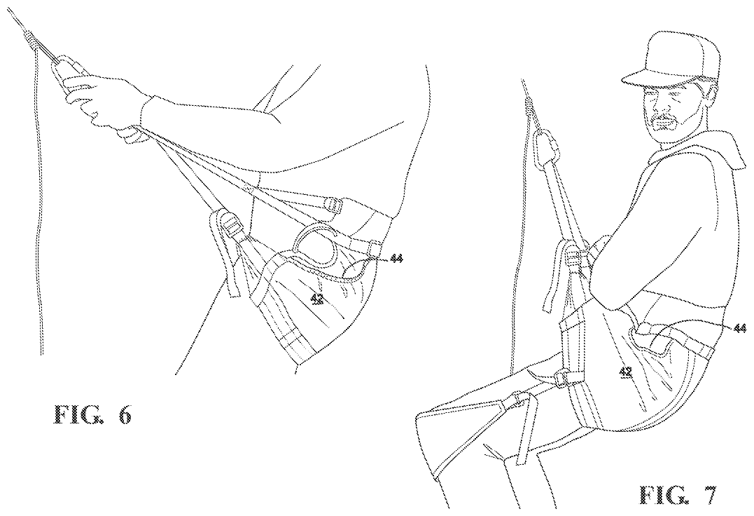

Turning now to FIGS. 6 and 7, along with FIG. 1, the construction of the pockets 42 are such that they remain fixed to the saddle 12 regardless of the position of the hunter H, including when suspended. The openings 44 are likewise fixed relative to the saddle 12 and positioned along the side portions 18 to be adjacent to the hips of the hunter at all times. The orientation of the openings 44 provide ready access to the pockets 42 in all positions. FIGS. 1 and 6 illustrate a standing position of the hunter H while suspended in the tree T, in which the hunter H has feet supported on a platform and is leaning back away from the tree at about a 30 to 45 degree angle relative to the central axis of the tree T. While in this standing position, the openings 44 are generally parallel to the ground (i.e., generally horizontal), but may range from 0 to about 15 degrees from parallel. FIG. 7 illustrates the hunter H when moved to a sitting position, with knees bent and femurs further toward parallel than the standing position. The hunter's knees may brace against the tree T while in the sitting position. The opening 44 while in the sitting position may range from 15 to 30 degrees tilted relative to horizontal. In both the standing and sitting positions, the openings 44 of the pockets 42 are easily accessible from above by the hunter and their locations relative to the saddle 12 do not move.

A method of supporting the hunter H suspended in the tree T with access to a storage pouch is also provided. The method includes the steps of providing a saddle 12 as described above made of flexible saddle fabric 14 having the main body portion 16 and the side portions 18 extending in opposite lateral directions from the main body portion 14. The method further includes arranging the saddle 12 to position the main body portion 16 about the hunter's back side and to wrap the side portions 18 along the hips of the hunter H. The saddle 12 is attached to a tether line L secured to the tree T to suspend the saddle 12 and hunter H and to enable the hunter H to move between a seated position and a standing position. The method includes providing the at least one integral pocket panel 46 fixed on the saddle 12 to define a storage pocket for holding selected items and which moves with the saddle 12 and hunter H between the seated and standing positions and which includes the opening 44 of the storage pocket 42 positioned along at least one of the side portions 18 for access by the hunter H when in the seated and standing positions.

The above description is directed to one or more preferred embodiments of the invention and is descriptive and exemplary rather than limiting. The invention is defined in the claims. Those of ordinary skill in the art will appreciate that variations of the disclosed embodiments are possible as well as other embodiments that fall within the scope of the appended claims and are contemplated by the invention.

What is claimed is:

1. A hunting saddle assembly, comprising:
a saddle made of a sling of flexible saddle fabric having a main body portion forming a seat for supporting the backside of a hunter and having side portions extending in opposite lateral directions from the main body portion for wrapping about the hips of the hunter;
at least one coupling connectible to a tether line for suspending the saddle and hunter in a tree; and
including at least one pocket formed as an integral part of the saddle having an opening positioned along at least one of the side portions and accessible to the hunter while suspended in the tree.

2. The assembly of claim 1, wherein the at least one pocket comprises a panel of flexible pocket fabric secured to the saddle fabric.

3. The assembly of claim 2, wherein the panel of flexible pocket fabric is external to the saddle fabric.

4. The assembly of claim 3, wherein the pocket fabric is a different material than the saddle fabric.

5. The assembly of claim 4, wherein the pocket fabric is elastically stretchable and the volume of the pocket is elastically expandable.

6. The assembly of claim 5, wherein the opening is elastically expandable.

7. The assembly of claim 6, wherein the at least one pocket comprises a panel of the pocket fabric sewn to the saddle fabric along at least a bottom edge thereof.

8. The assembly of claim 7, wherein the panel of pocket fabric includes a top edge that is relatively shorter than the bottom edge and is sewn to the saddle fabric; the panel of pocket fabric further including a back edge that extends transversely of the bottom edge and top edge and is sewn to the saddle fabric; the panel further including a forward edge that is relatively shorter than the back edge and is sewn to the saddle fabric; and the panel of pocket fabric further including a forwardly disposed rim portion that extends between the top and forward edges of the panel and that is not sewn to the saddle fabric and which defines the opening of the pocket.

9. The assembly of claim 8, wherein the rim portion extends at an acute angle between the top and forward edges of the panel.

10. The assembly of claim 9, wherein the forward edge is spaced forwardly of the top edge.

11. The assembly of claim 10, wherein the saddle includes a belt line and wherein the opening is angled relative to the belt line.

12. The assembly of claim 6, wherein there are at least two of the pockets having their openings disposed along the respective side portions of the saddle.

13. The assembly of claim 12, wherein the openings of the at least two pockets are oppositely inclined.

14. The assembly of claim 10, wherein the acute angle is between 10 degrees and 45 degrees.

15. The assembly of claim 14, wherein the at least two pockets have mirror symmetry.

16. The assembly of claim 1, wherein the opening of the at least one pocket is disposed at an angle ranging from 0-30 degrees from horizontal when the hunter is suspended in the tree and moves between a sitting position and a standing position.

17. A hunting saddle assembly, comprising:
a saddle made of a sling of flexible saddle fabric having a main body portion forming a seat for supporting the backside of a hunter and having side portions extending in opposite lateral directions from the main body portion for wrapping about the hips of the hunter;
at least one coupling connectible to a tether line for suspending the saddle and hunter in a tree; and
including at least two pocket panels fabricated of elastically stretchable fabric panels sewn externally to the saddle fabric and having openings disposed along the side portions of the saddle which are angled for access by the hunter when suspended in the tree.

18. A method of supporting a hunter suspended in a tree with access to a storage pouch, comprising:
providing a saddle made of flexible saddle fabric having a main body portion and side portions extending in opposite lateral directions from the main body portion;
arranging the saddle to position the main body portion about the hunter's back side and to wrap the side portions along the hips of the hunter;
attaching the saddle to a tether line secured to the tree to suspend the saddle and hunter and to enable the hunter to move between a seated position and a standing position; and
providing at least one integral pocket panel fixed on the saddle to define a storage pocket for holding selected items and which moves with the saddle and hunter between the seated and standing positions and including an opening of the storage pocket positioned along at least one of the side portions for access by the hunter when in the seated and standing positions.

19. The method of claim 18, wherein there are at least two of the pocket panels provided on opposite sides of the saddle each formed of elastically stretchable fabric to provide expandable volumes of the storage pockets and the respective openings of the storage pockets.

20. The method of claim 19, wherein the openings of the storage pockets are angled to be oriented generally horizontally when the hunter is in the standing position and within 15-30 degrees from horizontal when the hunter is in the seated position.

21. A hunting saddle assembly, comprising:
a saddle made of a sling of flexible saddle fabric having a main body portion forming a seat for supporting the backside of a hunter, the saddle including beltline webbing and lower webbing;
a bridge loop projecting forward of the saddle and supporting the beltline and lower webbings for attachment to a tether line secured to a tree for suspended support of the hunter; and
wherein the saddle includes a backrest portion extending above the beltline and including adjustable length straps projecting from opposite end regions of the backrest portion and secured to the bridge for adjusting fore and aft positioning of the backrest portion.
